(19) United States
(12) Patent Application Publication
(10) Pub. No.: US 2010/0051403 A1
(43) Pub. Date: Mar. 4, 2010

(54) DRIVING MECHANISM AND WHEEL ASSEMBLY FOR TOY CAR

(75) Inventor: JIN-SHI LAI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/266,503

(22) Filed: Nov. 6, 2008

(30) Foreign Application Priority Data
Aug. 28, 2008 (CN) 200810304257.0

(51) Int. Cl. F16D 7/04; F16D 43/20

(52) U.S. Cl. 192/56.61; 180/383

(57) ABSTRACT

A driving mechanism for driving a wheel of a toy car includes a motor, a first clutch, a second clutch, a guide shaft, a spring, and a limiting element. The first clutch driven by the motor has an engaging end surface defining a center hole thereon. The second clutch capable of latching with the wheel for driving the wheel has an engaging surface engaging with the engaging end surface. The second clutch defines a stepped hole substantially perpendicular to the engaging surface thereof, the stepped hole includes a first portion and a second portion. The guide shaft is disposed running through the stepped hole and has an end thereof fixed in the center hole. The spring sleeves the guide shaft and is compressed between the limiting element secured on the guide shaft and a stepped surface in the stepped hole.

### TECHNICAL FIELD

The present invention relates to toy cars, and particularly to a driving mechanism and wheel assembly for toy car.

### DESCRIPTION OF THE RELATED ART

A typical toy car has four wheels including two front wheels and two back wheels. The two front wheels are used for changing the direction of the toy car, and the two back wheels are driven by a motor to move the toy car. When movement of the back wheels are inhibited, the motor for driving thereof may be stopped correspondingly. However, the motor is still supplied with power, thereby, the coil assembly of the motor may be burned.

What is needed, therefore, is a driving mechanism and wheel assembly for toy car to overcome the above-described problem.

### BRIEF DESCRIPTION OF THE DRAWINGS

Many aspects of the present driving mechanism and wheel assembly for toy car can be better understood with references to the accompanying drawings. The components in the drawing are not necessarily drawn to scale, the emphasis instead being placed upon clearly illustrating the principles of the present driving mechanism and wheel assembly for toy car.

FIG. 1 is a schematic, partially exploded view of a wheel assembly including two wheels and two driving mechanism according to a first exemplary embodiment.

FIG. 2 is an exploded view of the driving mechanism of the wheel assembly of FIG. 1.

FIG. 3 is an exploded schematic view of a clutch assembly of the driving mechanism of FIG. 2.

### DETAILED DESCRIPTION OF THE EMBODIMENTS

Embodiments of the present invention will now be described in detail below, with references to the accompanying drawings.

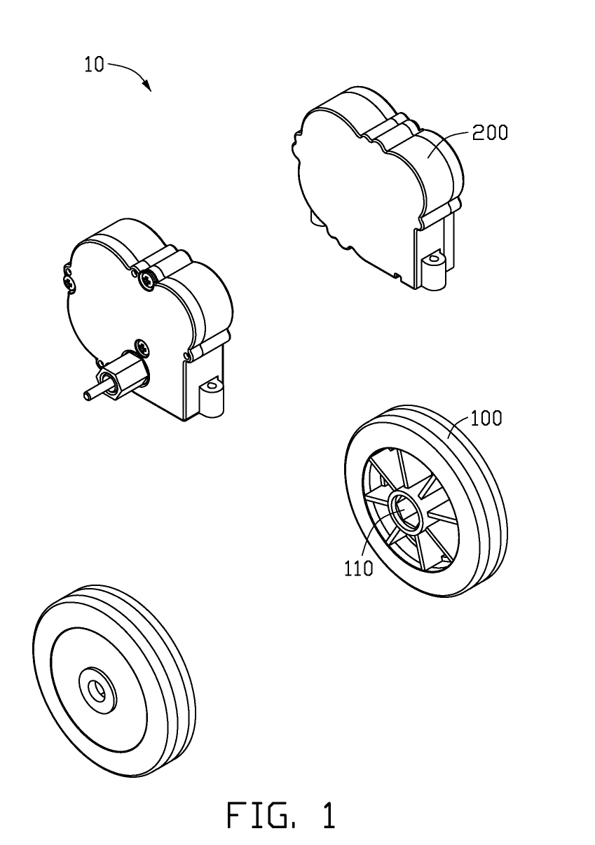

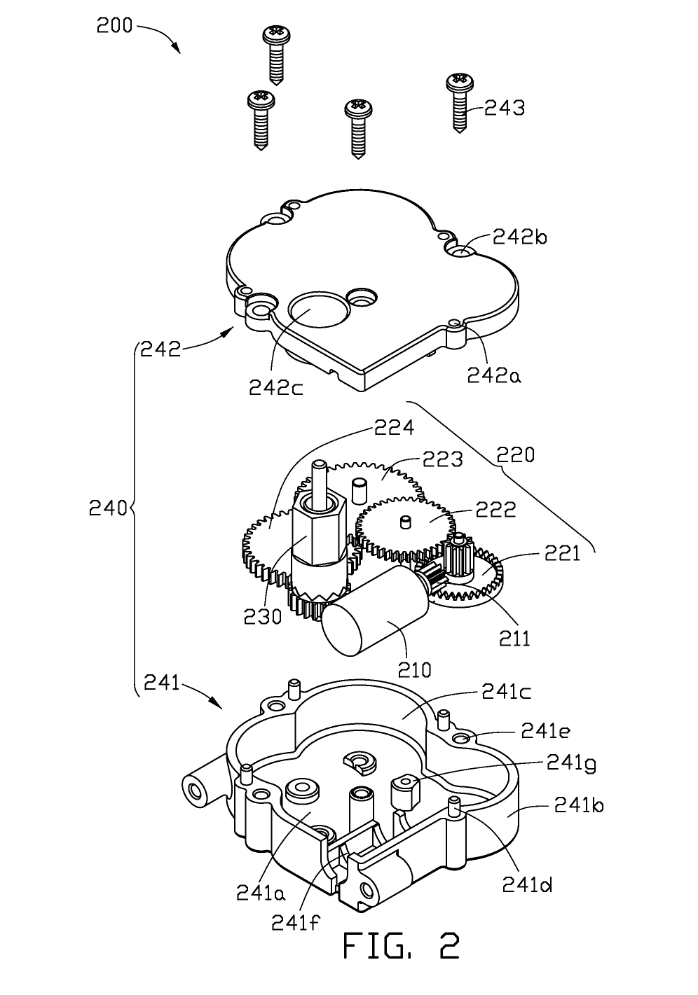

Referring to FIGS. 1 and 2, a wheel assembly 10 for a toy car according to a first exemplary embodiment is shown. The wheel assembly 10 includes two wheels 100 and two driving mechanisms 200 for driving the two wheels 100 respectively. The two wheels 100 are assembled on the toy car substantially coaxially.

The driving mechanism 200 includes a motor 210, a number of transmission gears 220, a clutch section 230, and a casing 240. The casing 240 receives the motor 210, the transmission gears 220, and a part of the clutch section 230 therein.

In the present embodiment, the casing 240 includes a receiving portion 241 and a cover 242.

The receiving portion 241 includes a bottom board 241a and a side wall 241b substantially perpendicularly extending from the bottom board 241a and surrounding the bottom board 241a. The bottom board 241a cooperates with the side wall 241b and defines a receiving space 241c for receiving the motor 210, the transmission gears 220, and a part of the clutch section 230. The end surface of the side wall 241b away from the bottom board 241a has a number of guide post 241d and defines a number of screw holes 241e. A bracket 241f and a number of bushings 241g are fixed on the bottom board 241a and received in the receiving space 241c. The bracket 241f is configured for mounting the motor 210, and the bushings 241g are configured for receiving rotating shafts of the transmission gears 220 and the clutch section 230.

The cover 242 defines a number of guiding holes 242a corresponding to the guide post 241d, and a number of screw holes 242b corresponding to the screw holes 241e. The cover 242 also defines an opening 242c permitting a part of the clutch section 230 extending out from the casing 240. The receiving portion 241 and the cover 242 are fixed together by a number of screws 243 engaging with the screw holes 242b and the screw holes 241c.

In the present embodiment, the motor 210 is mounted on the bracket 241f of the casing 240 and with the rotating axis thereof substantially parallel to the bottom board 241a. A motor gear 211 is connected to the motor 210 and rotatable by the motor 210.

The transmission gears 220 are disposed in the casing 240 with their rotating axis substantially perpendicular to the bottom board 241a. Because the length of the motor 210 is relatively longer than the diameter and the thickness of the transmission gears 220 are relative small compared to the diameter, by locating the motor 210 with the rotating axis thereof substantially parallel to the bottom board 241a, and the transmission gears 220 with the rotating axis thereof substantially perpendicular to the bottom board 241a, the receiving space 241c of the casing 240 can be used efficiently and the volume of the casing 240 can be decreased. In the present embodiment, the transmission gears 220 are reduction gears and include a first gear 221, a second gear 222, a third gear 223, and a fourth gear 224 meshed in sequence. The first gear 221 meshes with the motor gear 211 rotatable by the motor 210.

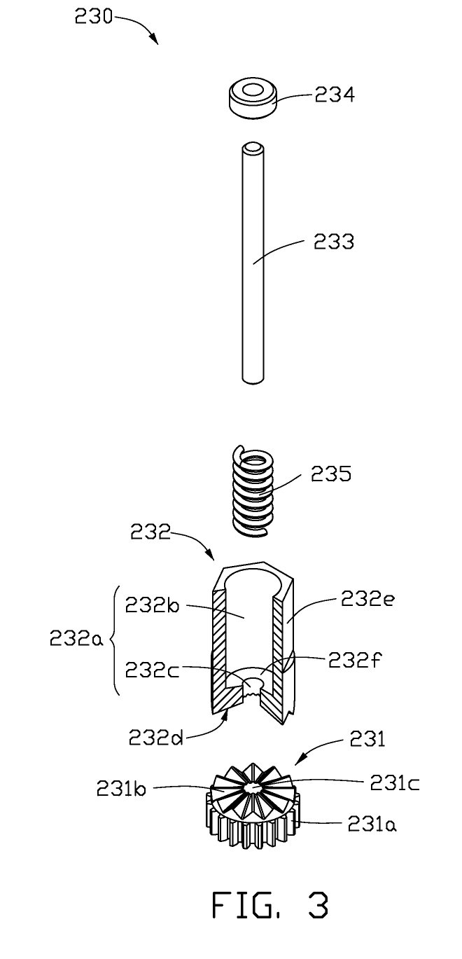

Referring to FIG. 3, the clutch section 230 includes a first clutch 231, a second clutch 232, a guide shaft 233, a limiting ring 234, and a spring 235.

The first clutch 231 is a cylinder having a toothed circumference surface 231a, for meshing with the fourth gear 224, and an engaging end surface 231b. The first clutch 231 defines a center hole 231c capable of fixing an end of the guide shaft 233. In the present embodiment, the end surface 231b has a number of teeth extending from the edge of the center hole 231c along the radial direction thereof.

The second clutch 232 includes a toothed end surface 232d capable of meshing with the engaging end surface 231b and defines a stepped hole 232a running through the second clutch 232. The axis of the stepped hole 232a is perpendicular to the end surface 232d. The stepped hole 232a includes a guiding hole 232c and a receiving hole 232b along a direction away from the end surface 232d. The diameter of the guiding hole 232c is smaller than that of the receiving hole 232b to form a stepped surface 232f between the guiding hole 232c and the receiving hole 232b. The second clutch 232 has a latching portion 232e away from the end surface 232d. When the clutch is assembled in the casing 240, the second clutch 232 extends out of the casing 240 from the opening 242c. The latching portion 232e is configured for latching with the wheel 100. In the present embodiment, the radial cross section of the latching portion 232e is a polygon. The wheel 100 has a center hole 110 which radial cross section is a polygonal for latching with the latching portion 232e, in order that the wheel 100 rotates with the second clutch 232.

The guide shaft 233 is disposed through the stepped hole 232a of the second clutch 232 and having an end thereof fixed in the center hole 231c of the first clutch 231. The diameter of the guide shaft 233 is equal to or smaller than that of the guiding hole 232c of the second clutch 232, so that, the second clutch 232 can slide along the guide shaft 233. The spring 235 sleeves the guide shaft 233 and is received in the receiving hole 232b of the second clutch 232. The outer diameter of the spring 235 is bigger than that of the guiding hole 232c. The limiting ring 234 sleeves the guide shaft 233 and is fixed on the guide shaft 233. The diameter of the limiting ring 234 is bigger than the inner diameter of the spring 235. The spring 235 is compressed between the limiting ring 234 and the stepped surface 232f of the stepped hole 232a.

Normally, the wheel 100 rotates together with the second clutch 232 when the motor 210 is operating, because the engaging surface 231b of the first clutch 231 and the engaging surface 232d of the second clutch 232 are pushed against each other by the elastic force of the compressed spring 235. However, when rotational movement of the wheel 10 is inhibited, the teeth on the engaging surface 231b disengages from the engaging surface 232d and the first clutch 231 is able to rotate separately from the second clutch 232, thereby preventing the motor 210 from burning up.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. A driving mechanism for driving a wheel of a toy car comprising:
a motor;
a first clutch driven by the motor, the first clutch comprising an engaging end surface defining a center hole thereon;
a second clutch capable of latching with the wheel for driving the wheel, the second clutch comprising an engaging surface capable of engaging with the engaging end surface of the first clutch, the second clutch defining a stepped hole running through the second clutch with the axis thereof substantially perpendicular to the engaging surface thereof, the stepped hole comprising a first portion, a second portion along a direction away from the engaging surface and a stepped surface defined between the first portion and second portion;
a guide shaft disposed through the stepped hole and having an end thereof fixed in the center hole of the first clutch;
a spring sleeved on the guide shaft and being received in the second portion; and
a limiting element secured on the guide shaft and keeping the spring compressed between the limiting element and the stepped surface in the stepped hole.

2. The driving mechanism as claimed in claim 1, wherein the engaging end surface of the first clutch has a plurality of teeth extending from the edge of the center hole along a radial direction thereof.

3. The driving mechanism as claimed in claim 1, wherein the second clutch has a latching portion away from the engaging surface thereof for latching with the wheel.

4. The driving mechanism as claimed in claim 3, wherein the radial cross section of the latching portion is a polygon.

5. The driving mechanism as claimed in claim 1, wherein the outer diameter of the spring is bigger than the diameter of the first portion and smaller than the diameter of the second portion, the inner diameter of the spring is bigger than the diameter of the guide shaft and smaller than the outer diameter of the limiting element.

6. The driving mechanism as claimed in claim 1, further comprising a casing, the casing comprising a receiving portion and a cover, the receiving portion comprising a bottom board and a sidewall substantially perpendicularly extending from the bottom board and surrounding the bottom board, the bottom board cooperating with the side wall to define a receiving space for receiving the motor and the first clutch, the cover defining an opening permitting the second clutch to project out of the casing.

7. The driving mechanism as claimed in claim 6, further comprising a plurality of transmission gears received in the receiving space of the casing for transmitting a driving force from the motor to the first clutch.

8. The driving mechanism as claimed in claim 7, wherein the transmission gears are reduction gears.

9. The driving mechanism as claimed in claim 7, wherein the motor is located with the rotating axis thereof substantially parallel to the bottom board, and the transmission gears are located with the rotating axis thereof substantially perpendicular to the bottom board.

10. The driving mechanism as claimed in claim 7, wherein the casing comprises a bracket for securing the motor and a plurality of bushings for receiving rotating shafts of the transmission gears.

11. A wheel assembly for a toy car comprising:
a plurality of wheels; and
at least two driving mechanisms for driving at two wheels of the plurality of wheels respectively, each driving mechanism comprising:
a motor;
a first clutch driven by the motor, the first clutch comprising an engaging end surface defining a center hole thereon;
a second clutch capable of latching with the wheel for driving the wheel, the second clutch comprising an engaging surface capable of engaging with the engaging end surface of the first clutch, the second clutch defines a stepped hole running through the second clutch with the axis thereof substantially perpendicular to the engaging surface thereof, the stepped hole comprising a first portion and a second portion along a direction away from the engaging surface and a stepped surface defined between the first portion and second portion;
a guide shaft disposed through the stepped hole and having an end thereof fixed in the center hole of the first clutch;
a spring sleeved on the guide shaft and being received in the second portion; and
a limiting element secured on the guide shaft and keeping the spring compressed between the limiting element and a stepped surface in the stepped hole.

12. The wheel assembly as claimed in claim 11, wherein the engaging end surface of the first clutch has a plurality of teeth extending from the edge of the center hole along a radial direction thereof.

13. The wheel assembly as claimed in claim 11, wherein the second clutch has a latching portion away from the engaging surface thereof, and the wheel defines a center hole for latching with the latching portion.

14. The wheel assembly as claimed in claim 13, wherein the radial cross section of the latching portion is a polygon.

15. The wheel assembly as claimed in claim 11, wherein the outer diameter of the spring is bigger than the diameter of the first portion and smaller than the diameter of the second portion, the inner diameter of the spring is bigger than the diameter of the guide shaft and smaller than the outer diameter of the limiting element.

16. The wheel assembly as claimed in claim 11, wherein the driving mechanism further comprises a casing, the casing comprises a receiving portion and a cover, the receiving portion comprises a bottom board and a sidewall substantially perpendicularly extending from the bottom board and surrounding the bottom board, the bottom board cooperates with the side wall to define a receiving space for receiving the motor and the first clutch, the cover defines an opening permitting the second clutch out of the casing.

17. The wheel assembly as claimed in claim 16, wherein the driving mechanism further comprises a plurality of transmission gears received in the receiving space of the casing for transmitting a driving force from the motor to the first clutch.

18. The wheel assembly as claimed in claim 17, wherein the motor is located with the rotating axis thereof substantially parallel to the bottom board, and the transmission gears are located with the rotating axis thereof substantially perpendicular to the bottom board.

19. The wheel assembly as claimed in claim 11, wherein the wheel assembly has two driving mechanisms for driving two wheels, and the two wheels are substantially coaxially on the toy car.
